(19) United States
(12) Patent Application Publication
(10) Pub. No.: US 2025/0284172 A1
(43) Pub. Date: Sep. 11, 2025

(54) DISPLAY PANEL AND DISPLAY APPARATUS

(71) Applicant: SHANGHAI TIANMA MICROELECTRONICS CO., LTD., Shanghai (CN)

(72) Inventors: Qingqing SUN, Shanghai (CN); Jian JIN, Shanghai (CN)

(21) Appl. No.: 19/217,182

(22) Filed: May 23, 2025

(30) Foreign Application Priority Data
Nov. 5, 2024 (CN) 202411573235.X

(51) Int. Cl. G02F 1/1679; G02F 1/167; G02F 1/1675

(52) U.S. Cl. CPC G02F 1/1679; G02F 1/167; G02F 2001/1678

(57) ABSTRACT

Provided are a display panel and a display apparatus including the same. The display panel includes: a first substrate and a second substrate provided opposite to each other; an electrophoretic display layer located between the first substrate and the second substrate, where the electrophoretic display layer includes dams and accommodating cavities defined by the dams, and an electrophoretic medium is provided in the accommodating cavities; and a sealing layer located between the electrophoretic display layer and the first substrate; where the electrophoretic medium includes a first additive, and a surface energy of the first additive is less than a surface energy of the electrophoretic medium. In the display panel and the display apparatus, the adhesive force of the sealing layer to the dams can be increased, improving a bonding strength of liquid-liquid interface contact, which is conducive to improving the sealability of flexible packaging.

### CROSS-REFERENCE TO RELATED APPLICATION

The present application claims priority to Chinese Patent Application No. 202411573235.X, filed on Nov. 5, 2024, the content of which is incorporated herein by reference in its entirety.

### TECHNICAL FIELD

The present disclosure relates to the field of organic electroluminescent technologies, and in particular, to a display panel and a display apparatus.

### BACKGROUND

Electronic paper display (EPD) is a thin, light, energy-saving and environmentally friendly display screen with good contrast and easy processing. As early as the 1970s, electrophoretic display technology was first reported. However, at the end of the 20th century, E-Ink Corporation in the United States adopted microcapsule packaging technology, which greatly promoted the industrialization development of electronic paper display.

Existing flexible display apparatuses all have certain bending performance. The bonding strength of liquid-liquid interface contact is insufficient. The adhesive force of the adhesive to the dams is weak, which cannot achieve the weather fastness of flexible packaging, affecting the stability and usability of the display screen.

Therefore, the liquid-liquid interface bonding strength of the existing flexible packaging is not enough, and the packaging structure is relatively complex.

### SUMMARY

The present disclosure aims to provide a display panel and a display apparatus. The display panel of the present disclosure can increase the adhesive force of the sealing layer to the dams, improving the bonding strength of liquid-liquid interface contact, and improving the sealability of flexible packaging.

In a first aspect, an embodiment of the present disclosure provides a display panel including a first substrate and a second substrate provided opposite to each other; an electrophoretic display layer located between the first substrate and the second substrate, where the electrophoretic display layer includes dams and accommodating cavities defined by the dams, and an electrophoretic medium is provided in the accommodating cavities; and a sealing layer located between the electrophoretic display layer and the first substrate; where the electrophoretic medium includes a first additive, and a surface energy of the first additive is less than a surface energy of the electrophoretic medium.

In a second aspect, an embodiment of the present disclosure provides a display apparatus including a display panel, where the display panel includes: a first substrate and a second substrate provided opposite to each other; an electrophoretic display layer located between the first substrate and the second substrate, where the electrophoretic display layer includes dams and accommodating cavities defined by the dams, and an electrophoretic medium is provided in the accommodating cavities; and a sealing layer located between the electrophoretic display layer and the first substrate; where the electrophoretic medium includes a first additive, and a surface energy of the first additive is less than a surface energy of the electrophoretic medium.

### BRIEF DESCRIPTION OF DRAWINGS

In order to more clearly illustrate the embodiments of the present disclosure or the technical solutions in the related art, the following is a brief introduction to the drawings required to be used in the description of the embodiments or the prior art. Apparently, the drawings in the following description are only some embodiments of the present application. For those of ordinary skill in the art, other drawings may also be derived from these figures.

FIG. 1 is an exploded structural schematic diagram of a display panel provided by an embodiment of the present disclosure;

FIG. 2 is a structural schematic diagram of a display panel provided by Embodiment One of the present disclosure;

FIG. 3 is a structural schematic diagram of yet another display panel provided by Embodiment Two of the present disclosure;

FIG. 4 is a diagram of an encapsulation state of the display panel provided by Embodiment Two of the present disclosure;

FIG. 5 is a structural schematic diagram of yet another display panel provided by Embodiment Three of the present disclosure;

FIG. 6A is a schematic diagram of a hydrogen bonding connection between a sealing layer and an electrophoretic medium in a display panel provided by an embodiment of the present disclosure;

FIG. 6B is a schematic diagram of a dipole connection between a sealing layer and a first substrate in a display panel provided by an embodiment of the present disclosure;

FIG. 7 is a structural schematic diagram of yet another display panel provided by Embodiment Four of the present disclosure;

FIG. 8A is a structural schematic diagram of yet another display panel provided by Embodiment Five of the present disclosure;

FIG. 8B is a transmission electron microscopy image of a cross-section of the yet another display panel provided by Embodiment Five of the present disclosure; and

FIG. 9 is a structural schematic diagram of a display apparatus provided by an embodiment of the present disclosure.

### DESCRIPTION OF EMBODIMENTS

In order to better understand the technical solutions of the present disclosure, embodiments of the present disclosure are described in detail below in conjunction with the accompanying drawings.

It should be noted that the described embodiments are merely some but not all of the embodiments of the present disclosure. Based on the embodiments in the present disclosure, all other embodiments obtained by those ordinary skilled in the art without creative efforts shall fall within the protection scope of the present disclosure.

The terms used in the embodiments of the present disclosure are merely for the purpose of describing particular embodiments and are not intended to limit the present disclosure. Unless clearly indicated otherwise in the context, the singular forms “a/an”, “the”, and “said” used in the embodiments and appended claims of the present disclosure are intended to include plural form as well.

It should be understood that the term “and/or” used herein is merely an association relationship describing associated objects, indicating that there may be three relationships, for example, A and/or B may indicate that A exists alone, A and B exist simultaneously, and B exists alone. In addition, the character “/” herein generally indicates that the associated objects before and after the character are in “or” relationship.

The existing flexible electrophoretic display panel has certain bending performance. The bonding strength of contact between liquid-liquid interfaces is not enough. The adhesive force of the adhesive to the dams is weaker, which cannot ensure the weather fastness of flexible packaging, affecting the stability and usability of the display screen.

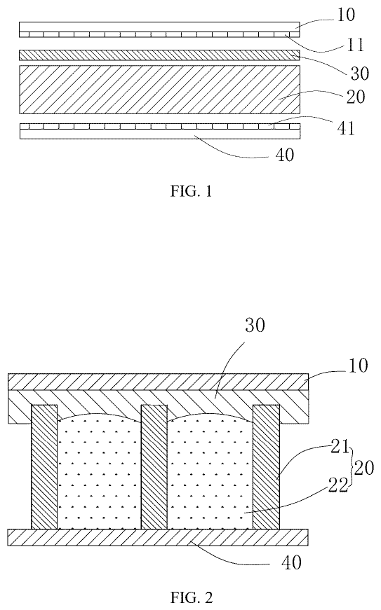

Therefore, the bonding strength between the liquid-liquid interfaces in the existing flexible packaging is not enough, and the packaging structure is relatively complex. FIG. 1 is an exploded structural schematic diagram of a display panel provided by an embodiment of the present disclosure. As shown in FIG. 1, the embodiment of the present disclosure provides a display panel including a first substrate 10 and a second substrate 40 provided opposite to each other; an electrophoretic display layer 20 located between the first substrate 10 and the second substrate 40; the electrophoretic display layer 20 includes dams and accommodating cavities defined by the dams, and an electrophoretic medium is provided in each of the accommodating cavities; and a sealing layer 30 located between the electrophoretic display layer 20 and the first substrate 10.

As shown in FIG. 1, the first substrate 10 may be a substrate with light-transmissivity and flexibility made of an insulating synthetic resin and the like, for example, a hard substrate such as a glass substrate or a plastic substrate, or a flexible substrate such as a PET film substrate. The first substrate 10 has a display surface, which can be a surface of the first substrate 10 away from the second substrate 40.

In the present disclosure, the first substrate 10 is a transparent substrate, which may be made of materials such as polyethylene terephthalate (PET), polyethylene (PE), polyimide (PI), polyethylene naphthalate (PEN) and the like. A first electrode 11 is formed on a surface of the first substrate 10 close to the electrophoretic display layer 20. Specifically, the first electrode 11 may be an indium tin oxide (ITO) film, a nano-silver wire, or a graphene film, etc. The first electrode 11 may be provided in an array pattern on the surface of the first substrate 10.

The second substrate 40 is spaced apart from the first substrate 10, and may also be a flexible substrate made of resin, or a hard substrate made of glass, plastic, and the like. The second substrate 40 may serve as a carrier for carrying other film layer structures in the display apparatus. A second electrode 41 is formed on a surface of the second substrate 40 close to the electrophoretic display layer 20, and the second electrode 41 may be provided in an array pattern for driving the electrophoretic medium 22 to form an image.

Both the first substrate 10 and the second substrate 40 are provided with electrodes for applying electrical signals to both sides of the electrophoretic display layer 20. The second electrode may be a pixel electrode of the display panel, and a voltage signal on a driving electrode is controlled by a controller to control the display of the electrophoretic display layer 20.

FIG. 2 is a structural schematic diagram of a display panel provided by Embodiment One of the present disclosure. As shown in FIG. 2, the electrophoretic display layer 20 includes the dams 21 and the accommodating cavities defined by the dams, and the electrophoretic medium 22 is provided in each of the accommodating cavities. The electrophoretic medium 22 includes electrophoretic fluid and electrophoretic particles distributed in the electrophoretic fluid. The electrophoretic particles are main components for achieving the display effect in the display panel. The electrophoretic particles may be spherical, square, polygonal, or other irregular shapes, which is not limited by the embodiment of the present disclosure. A plurality of first electrodes 11 and a plurality of second electrodes 41 form a pulsed electric field to drive the electrophoretic particles to rotate.

A thickness of the electrophoretic display layer 20 is specifically 10 μm to 1000 μm, specifically the thickness can be 10 μm, 50 μm, 100 μm, 300 μm, 500 μm, 600 μm, 800 μm, or 1000 μm, and of course the thickness can also be other values within the above range, which is not limited herein. The thickness of the electrophoretic display layer 20 may be further specifically 50 μm to 800 μm, and even more specifically may be 50 μm to 500 μm.

The sealing layer 30 is used for sealing the accommodating cavities formed by the dams 21. The material of the sealing layer 30 may be an adhesive, which includes oligomers or polymers containing crosslinkable groups such as acrylate or derivatives thereof, epoxy resin, epoxy resin derivatives, resin monomers and the like. After undergoing thermal radiation, light-curing and the like, the above-mentioned adhesive materials form the sealing layer, enabling the sealing layer 30 to form a continuous film on the surface of the electrophoretic medium. Of course, the adhesive further includes an organic solvent, and components of the organic solvent are not limited in the present disclosure.

In some implementations, the adhesive includes an acrylate prepolymer, a photoinitiator, a crosslinking agent, and a conductive material. In a specific preparation process, 52 parts by mass of isooctyl acrylate (EHA), 35 parts by mass of isobornyl acrylate (IBOA), 12 parts by mass of hydroxyethyl acrylate (HEA), 1 part by mass of acrylamide (AM), and 0.1 part by mass of hydroxycyclohexyl phenyl ketone are fully and uniformly mixed, and then subjected to 365 nm ultraviolet light irradiation to react until the viscosity reaches 3500 cps, thereby obtaining the acrylate prepolymer. The prepolymer is uniformly mixed with other additives (0.1% of photoinitiator TPO, 0.1% of crosslinking agent HDDA, and 2% of conductive material) to obtain the adhesive for the sealing layer. Exemplarily, the conductive material may be a conductive nanomaterial, for example carbon nanotubes, silver nanowires, graphene, fullerene, and the like. The conductive material may also be a conductive polymer such as polyaniline, polypyrrole, polythiophene, and polypropyleneamine polymers. The conductive material may also include an antistatic agent.

In some implementations, a coating thickness of the sealing layer 30 can be 10 μm to 50 μm, specifically the coating thickness can be 10 μm, 15 μm, 20 μm, 25 μm, 30 μm, 35 μm, 40 μm, 45 μm, or 50 μm, etc., and of course the coating thickness can also be other values within the above range, which is not limited herein. The sealing layer 30 is formed by coating an adhesive into a film, and a specific coating process may be a common method used by those of skill in the art. After coating and molding, light-curing or thermal curing is generally used to accelerate the molding of the sealing layer 30 and improve the flatness of the sealing layer.

In some implementations, the material for the dams 21 may be a thermoplastic material or a thermosetting material, and specifically acrylate, epoxy resin, epoxy resin derivatives and the like, which is not limited herein.

Two ends of each of the accommodating cavities defined by the dams 21 are open with one end facing the first substrate 10 and the other end facing the second substrate. The sealing layer 30 is provided between the first substrate 10 and the electrophoretic display layer 20. Any of the accommodating cavities formed by the dams 21 may be cube, sphere, ellipsoid, cone, or the like, which is not limited herein, as long as the accommodating cavity can accommodate the electrophoretic medium. FIG. 1 merely illustrates the structure and positional relationship in the display panel, and does not represent the actual size and shape of each layer structure.

The present disclosure further provides a method for manufacturing a display panel. The method includes steps of:
a. providing a first substrate 10 and a second substrate 40;
b. forming dams 21 on the second substrate 40, and filling a plurality of accommodating cavities defined by the dams 21 with an electrophoretic medium to form an electrophoretic display layer 20;
c. coating an adhesive on the electrophoretic display layer 20, and curing the adhesive to form a sealing layer 30 which connects the electrophoretic display layer and the first substrate 10, where the electrophoretic medium 22 directly contacts the sealing layer 30.

In some implementations, the sealing layer 30 may also be provided between the second substrate 40 and the electrophoretic display layer 20, thereby improving the bonding stability between the second substrate 40 and the electrophoretic display layer 20.

In order to improve the interface bonding strength between the sealing layer 30 and the electrophoretic display layer, in some implementations, the electrophoretic medium 22 includes a first additive having a surface energy less than a surface energy of the electrophoretic medium.

In the above technical solution, the electrophoretic medium of the display panel includes the first additive having the surface energy less than the surface energy of the electrophoretic medium, under the action of the first additive, the surface of the electrophoretic medium forms a centrally raised interface, and the electrophoretic medium forms an interface raised towards the sealing layer, so that the contact area between the sealing layer and the dams becomes increased, the bonding strength between the sealing layer and the dams is improved, and the bonding strength of the liquid-liquid interface contact is enhanced, thereby improving the sealing strength between the sealing layer and the electrophoretic display layer, which is conducive to improving the sealability of flexible packaging.

As observed by the transmission electron microscope, the electrophoretic medium 22 forms an interface raised towards the sealing layer 30. It can be understood that still referring to FIG. 2, since the electrophoretic medium 22 contains the first additive with a low surface energy, the first additive can migrate to the surface of the electrophoretic medium, so that the surface of electrophoretic medium 22 forms an interface raised towards the sealing layer.

In some implementations, a surface energy of the first additive is lower than 25 mN/m, specifically the surface energy can be 24 mN/m, 23 mN/m, 22 mN/m, 20 mN/m, 18 mN/m, 16 mN/m, 15 mN/m, or 10 mN/m, etc., and of course the surface energy can also be other values within the above range, which is not limited herein.

A surface energy of the electrophoretic medium is greater than 25 mN/m, specifically the surface energy can be 26 mN/m, 27 mN/m, 28 mN/m, 30 mN/m, 32 mN/m, 33 mN/m, 34 mN/m or 35 mN/m, etc., and of course the surface energy can also be other values within the above range, which is not limited herein. Since the surface energy of the first additive is lower than the overall surface energy of the electrophoretic medium, the first additive can migrate to the surface of the electrophoretic medium, so that the surface of electrophoretic medium 22 forms a centrally raised interface.

In some implementations, the first additive is a hydrophobic material, and a mass percentage of the hydrophobic material in the electrophoretic medium is 0.01% to 1%, and specifically the mass percentage can be 0.01%, 0.02%, 0.03%, 0.04%, 0.05%, 0.08%, 0.1%, 0.2%, 0.3%, 0.4%, 0.5%, 0.6%, 0.7%, 0.8%, 0.9%, or 1%, etc., and of course the mass percentage can be other values within the above range, which is not limited herein. Under the action of the hydrophobic material, the surface of the electrophoretic medium forms a centrally raised interface, the contact area between the adhesive covering the electrophoretic medium and the dams becomes larger, thereby improving the bonding strength between the sealing layer and the dams. Moreover, the hydrophobic material in the electrophoretic medium can also play a hydrophobic role, thereby improving the dispersion uniformity of the electrophoretic particles in the electrophoretic medium.

In some implementations, the hydrophobic material is selected from at least one of organosilicon hydrophobic agent, organofluorine hydrophobic agent, hydrocarbon hydrophobic agent, and silicon hydrophobic agent.

Specifically, the organosilicon hydrophobic agent has a surface tension of about 20 mN/m, and specifically can be siloxane compound, sodium methylsilicate, poly (methyl hydrogen) siloxane, etc.

The organofluorine hydrophobic agent has a surface tension of about 18 mN/m, and specifically can be perfluorooctane sulfonic acid, perfluorooctanoic acid, fluoroalkane sulfonic acid, fluorooctane sulfonic acid, perfluorocarbon hydrogen-based compounds, etc.

The hydrocarbon hydrophobic agent has a surface tension of about 30 mN/m, and specifically can be long-chain alkane, aromatic hydrocarbon, cycloalkane, etc.

The silicon-based hydrophobic agent can be, for example, fluorinated nano silicon monoxide. Preferably, the hydrophobic material includes polydimethylsiloxane (abbreviated to PDMS).

In some implementations, after peeling off the sealing layer 30 from the electrophoretic display layer 20, a surface drop angle of the sealing layer 30 close to the electrophoretic display layer 20 is 90° to 115°, and the surface drop angle specifically can be 90°, 100°, 105°, 110°, or 112°, etc., and of course the surface drop angle can also be other values within the above range, which is not limited herein. Due to the lower surface energy of the hydrophobic material, the hydrophobic material can migrate to the surface of the electrophoretic medium. Therefore, some of the hydrophobic material can adhere to the surface of the sealing layer 30, thereby enabling the surface drop angle of the sealing layer 30 to be low, being conducive to forming a centrally raised interface by the surface of the electrophoretic medium.

In some implementations, within a range of a single accommodating cavity among the accommodating cavities defined by the dams 21, an edge thickness H1 of the sealing layer 30 sealing the receiving cavity is greater than a middle thickness H2 of the sealing layer 30. From this, it can be seen that the sealing layer 30 tends to be thinner in the middle and thicker at the four-peripheral edges. This is because the surface of the electrophoretic medium forms a centrally raised interface, and the raised interface affects the structure of the sealing layer 30 formed by the adhesive.

In some implementations, 1 nm≤H1-H2≤100 nm, and specifically H1-H2 can be 1 nm, 2 nm, 3 nm, 4 nm, 5 nm, 10 nm, 15 nm, 20 nm, 30 nm, 50 nm, 80 nm or 100 nm, etc., which is not limited herein.

In some implementations, within a range of a single accommodating cavity among the accommodating cavities defined by the dams, an included angle between the surface of the sealing layer sealing the accommodating cavity and a side wall of one dam is less than 90°. In the present disclosure, after the packaged display panel is subjected to sectioning treatment, the included angle between the sealing layer and the side wall of the dam can be measured by using the transmission electron microscope. Preferably, the included angle is 10° to 60°. The sealing layer 30 with this structure can reduce the included angle between the sealing layer and the side wall of the dam 21. When the first additive is not added to the electrophoretic medium, the liquid surface of the electrophoretic medium is in a horizontal state as a whole, and the thickness of the sealing layer sealing the electrophoretic medium is also more uniform, and the included angle between the sealing layer 30 and the side wall of the dam 21 is about 90°.

In some implementations, the bonding strength between the sealing layer 30 and the electrophoretic display layer 20 is greater than or equal to 500 gf/25 mm, and specifically the bonding strength can be 500 gf/25 mm, 550 gf/25 mm, 580 gf/25 mm, 600 gf/25 mm, 650 gf/25 mm, or 700 gf/25 mm, etc., which is not limited herein.

In some implementations, an optical transmittance of the sealing layer is greater than 92%, and specifically the optical transmittance can be 92.5%, 93%, 93.5%, 94%, 95%, 96%, 97%, 98%, or 99% etc., and of course the optical transmittance can be other values within the above range. Due to the better optical transmittance of the sealing layer, it will not affect the electrophoretic particles from forming an image on the display surface of the first substrate.

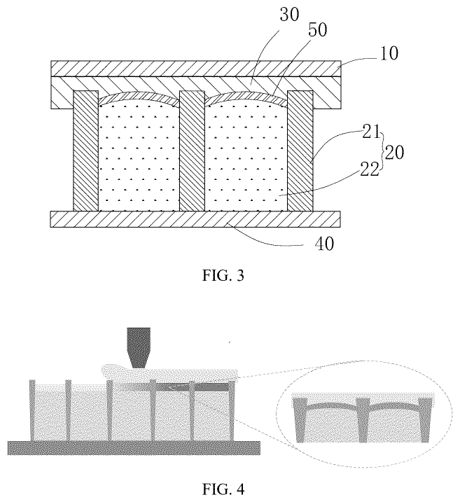

FIG. 3 is a structural schematic diagram of yet another display panel provided by Embodiment Two of the present disclosure. As shown in FIG. 3, the display panel further includes a bonding layer 50 located between the electrophoretic medium 22 and the sealing layer 30. The bonding layer 50 may be located on a surface of the sealing layer 30 close to the electrophoretic display layer 20, or may be a part of the sealing layer 30.

FIG. 4 is a schematic diagram of a packaging state of the display panel provided by Embodiment Two of the present disclosure. During the packaging process, the adhesive is coated on the surface of the electrophoretic display layer, and then the adhesive is cured through light-curing or thermal curing to form the sealing layer 30. During the light-curing or thermal curing reaction process, the additive in the electrophoretic medium can chemically react with the additive in the sealing layer to form the bonding layer.

In some implementations, the electrophoretic medium 22 includes a second additive, the sealing layer 30 includes a third additive, and the bonding layer 50 is formed by the reaction between the second additive and the third additive. As the second additive in the electrophoretic medium can react chemically with the third additive in the sealing layer, the bonding layer formed by the chemical reaction can further enhance the interface bonding strength between the sealing layer and the electrophoretic display layer.

In some implementations, a mass percentage of the second additive in the electrophoretic medium is 0.01% to 1%, and specifically the mass percentage can be 0.01%, 0.02%, 0.03%, 0.04%, 0.05%, 0.08%, 0.1%, 0.2%, 0.3%, 0.4%, 0.5%, 0.6%, 0.7%, 0.8%, 0.9%, or 1%, etc., and of course the mass percentage can be other values within the above range, which is not limited herein. In the present disclosure, by controlling the dosage of the second additive, the bonding strength between the sealing layer and the electrophoretic display layer can be improved and the structural reliability of the display apparatus can be enhanced without affecting the performance of the electrophoretic medium.

In some implementations, the second additive includes silicon-containing compound, and a chemical formula of the silicon-containing compound is shown in Formula I:

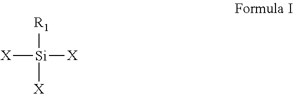

in the Formula I, X represents a hydrolyzable group, and R₁ is selected from an active group capable of interacting with an organic resin.

In some implementations, X is selected from halogen atom, alkoxy group, and acyloxy group. The halogen atom can be, for example, F, Cl, Br, I, etc.

R₁ is selected from at least one of amino, mercapto, vinyl, epoxy, cyano, and methacryloyloxy. The R₁ group can interact with an organic resin, and the interaction can be chemical reaction or physical adsorption, which is not limited herein.

In some implementations, the silicon-containing compound includes at least one of epoxy-amino silicone oil, amino-functional silane and γ-glycidoxypropyltrimethoxysilane, poly (methylhydrogen) siloxane, etc.

In some implementations, a mass percentage of the third additive in the sealing layer is 0.05% to 1%, and specifically the mass percentage can be 0.05%, 0.08%, 0.1%, 0.2%, 0.3%, 0.4%, 0.5%, 0.6%, 0.7%, 0.8%, 0.9%, or 1%, etc., and of course the mass percentage can be other values within the above range, which is not limited herein. In the present disclosure, by controlling the dosage of the third additive, the bonding strength between the sealing layer and the electrophoretic display layer can be improved and the structural reliability of the display apparatus can be improved without affecting the performance of the sealing layer.

In some implementations, the third additive includes a silane coupling agent, and the chemical formula of the silane coupling agent is R₂—Si(OM)₃, where R₂ is selected from an organic group, and OM represents a hydrolyzable alkoxy.

Specifically, R₂ may be selected from at least one of amino, vinyl, methyl, epoxy, mercapto, and acryloxypropyl. These groups all have stronger reaction capacities with different organic resins, and X is a hydrolyzable group.

The silane coupling agent includes at least one of amino silane coupling agent, epoxy silane coupling agent, alkenyl silane coupling agent, methacryloxy-containing silane coupling agent, and halogen-containing silane coupling agent. Exemplarily, the silane coupling agent is selected from at least one of vinyltriethoxysilane, epoxysilane, methacryloxysilane, γ-glycidoxypropyltrimethoxysilane, γ-methacryloxypropyltrimethoxysilane, mercaptopropyltrimethoxysilane, dodecyltrimethoxysilane, and methylphenyldimethoxy silane.

The hydrolysis reaction mechanism of the silicon-containing compound is shown in Formula (a):

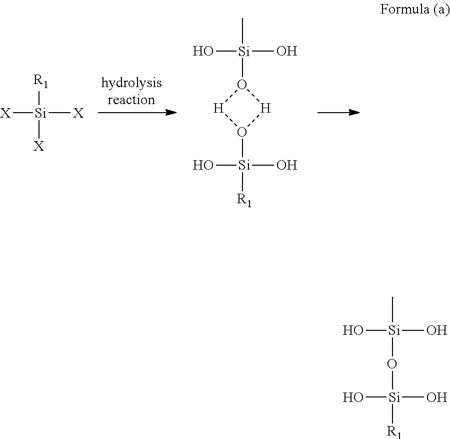

The silicon-containing compound is first undergo a hydrolysis reaction, then form oligomers through dehydration condensation, and subsequently react with the hydroxyl groups and the like in the organic resin, thereby achieving the coupling effect with the organic resin.

Further, the Si—OH groups formed by hydrolysis of the silicon-containing compound can react with the Si—OH groups formed by hydrolysis of the silane coupling agent to form Si—O—Si chemical bonds. Through dehydration condensation, the silicon-containing compound in the electrophoretic medium can chemically react with the silane coupling agent in the adhesive for forming the sealing layer, so that the bonding layer has Si—O—Si chemical bonds. In the actual test process, after peeling off the sealing layer 30 from the electrophoretic display layer 20, the surface of the sealing layer 30 close to the electrophoretic display layer 20 can be analyzed by infrared spectroscopy, and the Si—O—Si chemical bonds can be measured. The bonding layer formed by the chemical reaction can enhance the interfacial connection acting force between the electrophoretic medium and the sealing layer formed by the adhesive, thereby improving the liquid-liquid interface bonding strength.

In some implementations, the silane coupling agent can also chemically react with organic and inorganic groups to form a chemical bond or undergo physical adsorption, so that a strong bond can also be formed between the sealing layer and the first substrate, thereby improving the bonding strength, and increasing the structural reliability of the display apparatus. Specifically, the organic functional group R₂ in the silane coupling agent can form a chemical bond with the substrate (for example plastic).

It should be noted that the second additive in the electrophoretic medium and the third additive in the sealing layer can also be the same, for example, both are silane coupling agent. The second additive reacts with the third additive to form Si—O—Si chemical bonds, so that the bonding layer 50 is formed between the electrophoretic medium and the adhesive (the sealing layer), thereby improving the liquid-liquid interface bonding strength. The silane coupling agent in the sealing layer can also enable the strong bond to be formed between the sealing layer and the second substrate, thereby improving bonding strength and increasing structural reliability of the display apparatus.

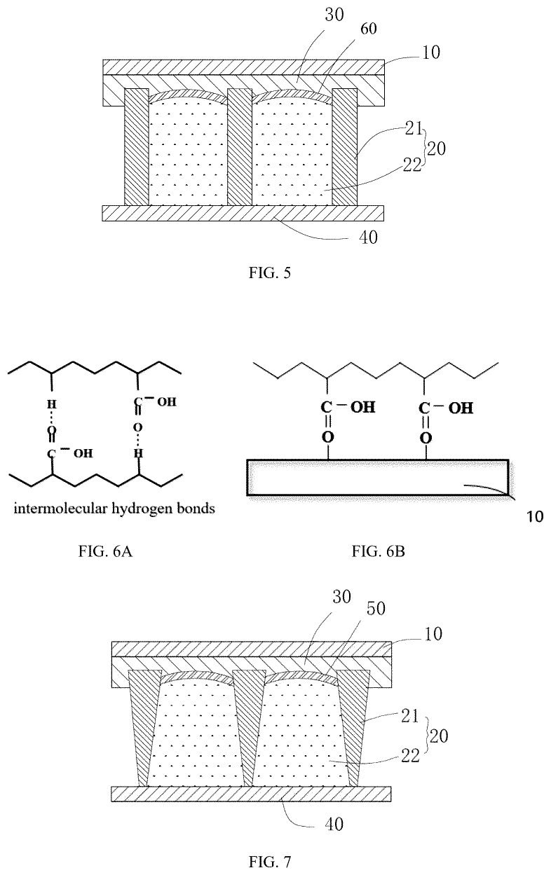

FIG. 5 is a structural schematic diagram of yet another display panel provided by Embodiment Three of the present disclosure. Different from Embodiment I, as shown in FIG. 5, the display panel further includes a hardened layer 60 located between the electrophoretic medium 22 and the sealing layer 30. The hardened layer 60 may be located on a surface of the sealing layer 30 close to the electrophoretic display layer 20, or may be a part of the sealing layer 30.

The forming mechanism of the hardened layer 60 is similar to the forming mechanism of the bonding layer 50. During the packaging process, the adhesive is coated on the surface of the electrophoretic display layer, so that the adhesive is cured to form the sealing layer 30. The additive in the electrophoretic medium can undergo a crosslinking reaction with the active group on the prepolymer in the adhesive to form the hardened layer 60, thereby improving the weather fastness of the adhesive for packaging to the electrophoretic medium and improving the stability of the packaging structure.

In some implementations, the electrophoretic medium 22 includes a fourth additive. A density of the fourth additive is lower than a density of the electrophoretic medium. Due to the lower density of the fourth additive, the fourth additive can float up to the liquid surface of the electrophoretic medium, thereby the liquid surface of the electrophoretic medium forms a centrally raised interface, so that the contact area between the adhesive covering the electrophoretic medium and the dams is increased, thereby improving bonding strength between the sealing layer and the dams.

In some implementations, the hardened layer 60 is formed by the crosslinking reaction between the fourth additive and the sealing layer 30, the fourth additive has a first active group, the adhesive for forming the sealing layer 30 has a second active group, and the first active group and the second active group are each independently selected from at least one of a carbon-carbon double bond, a hydroxyl group, a carboxyl group, an amino group, an epoxy group, an aldehyde group, and a haloalkyl group.

In some implementations, the fourth additive includes a multifunctional acrylic monomer with a density less than 1.2 g/mL. Specifically, the multifunctional acrylic acid monomer includes at least one of ethylene glycol diacrylate (EGDA, 1.1 g/mL), 1,6-hexanediol diacrylate (HDDA, 1.01 g/mL), 1,4-butanediol diacrylate (BDDA, 1.051 g/mL), trimethylolpropane triacrylate (TMPTA, 1.108 g/mL), ethoxylated trimethylolpropane triacrylate (TMPEOTA, 1.098 g/mL), tetraethylene glycol dimethacrylate (1.082 g/mL), trimethylolpropane trimethacrylate (1.06 g/mL), propoxylated trimethylolpropane triacrylate (1.054 g/mL), propoxylated glycerol triacrylate (1.11 g/mL), and pentaerythritol triacrylate (1.18 g/mL).

In some implementations, a mass percentage of the fourth additive in the electrophoretic medium is 0.1% to 1%, specifically the mass percentage can be 0.1%, 0.2%, 0.3%, 0.4%, 0.5%, 0.6%, 0.7%, 0.8%, 0.9%, or 1%, etc., and of course the mass percentage can also be other values within the above range, which is not limited herein.

In some implementations, the first active group of the fourth additive undergoes a crosslinking reaction with the second active group in the adhesive. Through Fourier-transform infrared spectroscopy (FTIR) testing, the surface of the sealing layer close to the electrophoretic display layer has intermolecular hydrogen bonds, that is, the hardened layer has intermolecular hydrogen bonds.

In some implementations, the material of the sealing layer 30 may include polyacrylate and/or polymethacrylate, and a number-average molecular weight of the adhesive is 200,000 to 1,500,000. Taking the material of the sealing layer 30 as polyacrylate as an example, as shown in FIG. 6A, the molecular chain of polyacrylate has active groups such as hydroxyl and carboxyl, and the fourth additive, polyfunctional acrylic monomer, also has active groups, which can crosslink with the active groups on the molecular chain of polyacrylate to form hydrogen bonds.

In some implementations, the materials of the dams 21 and the first substrate 10 are both polymers with polar groups, for example polyester and polyamide, which all contain polar groups. Taking the material of the sealing layer 30 as polyacrylate as an example, as shown in FIG. 6B, the sealing layer 30 is connected to the dams 21 and the first substrate 10 through dipole-dipole interaction, which can improve the bonding force of the sealing layer 30 to the dams and enhance the interfacial bonding force between the sealing layer 30 and the first substrate 10.

In some implementations, a Shore hardness of the hardened layer is greater than 50 HA, specifically the Shore hardness can be 51 HA, 55 HA, 58 HA, 60 HA, 65 HA, 70 HA, 80 HA, or 90 HA, etc., and of course the Shore hardness can also be other values within the above range, which is not limited herein.

FIG. 7 is a structural schematic diagram of yet another display panel provided by Embodiment Four of the present disclosure. As shown in FIG. 7, an orthographic projection area of a top surface of the dam 21 away from the second substrate 40 on the second substrate 40 is greater than an orthographic projection area of a bottom surface of the dam 21 close to the second substrate 40 on the second substrate 40.

The accommodating cavities formed by the dams 21 with this structure each presents a shape that is wide at the top and narrow at the bottom, so that the side wall of the dam 21 can be in an inclined state, thereby increasing the contact area between the side wall of the dams and the sealing layer and enhancing the bonding strength between the sealing layer and the electrophoretic display layer.

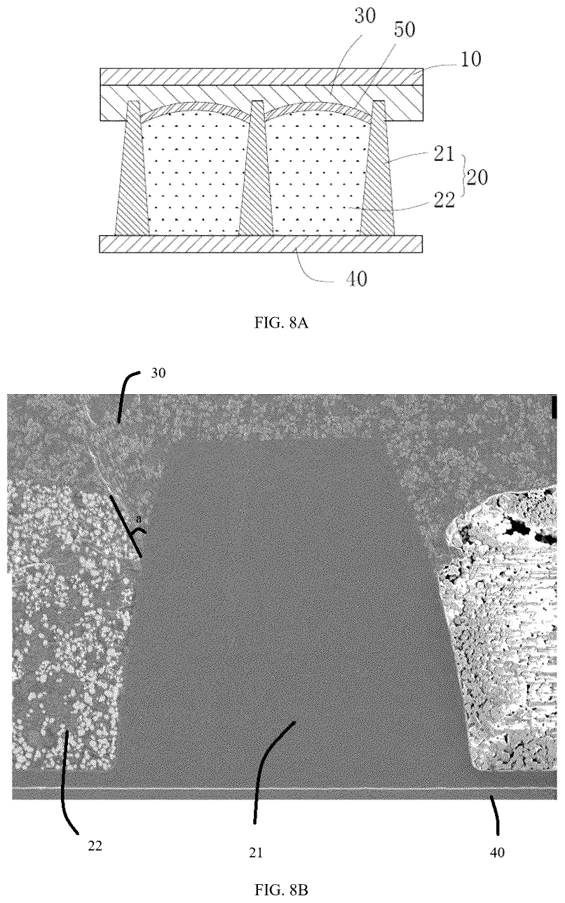

FIG. 8A is a structural schematic diagram of yet another display panel provided by Embodiment Five of the present disclosure, and FIG. 8B is a transmission electron microscopy image of a cross-section of the yet another display panel provided by Embodiment Five of the present disclosure. As shown in FIG. 8A and FIG. 8B, the orthographic projection area of the top surface of the dam 21 away from the second substrate 40 on the second substrate 40 is smaller than the orthographic projection area of the bottom surface of the dam 21 close to the second substrate 40 on the second substrate 40. In this case, as shown in FIG. 8B, under the action of the additive in the electrophoretic medium 22, the electrophoretic medium can form a raised interface. Within the range of a single accommodating cavity of the accommodating cavities defined by the dams, the included angle α between the surface of the sealing layer 30 sealing the accommodating cavity and the side wall of the dam 21 can be kept less than 90°.

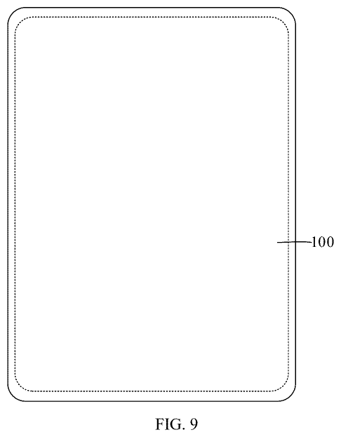

FIG. 9 is a schematic view of a display apparatus provided by an embodiment of the present disclosure. As shown in FIG. 9, the display apparatus includes the display panel 100 as provided by any of the above embodiments. Exemplarily, the display apparatus may be a display screen(s) of a mobile phone, a computer, a television, a vehicle-mounted display, a wearable electronic device, or various smart devices, etc.

The present disclosure is further described below in multiple embodiments.

### Embodiment One

A method for manufacturing a display apparatus includes steps of:
(1) providing a first substrate (PET substrate) and a second substrate (glass substrate), a surface of the first substrate being provided with a first electrode, a surface of the second substrate being provided with a second electrode, and both the first electrode and the second electrode being made of indium tin oxide;
(2) installing dams on the surface of the second substrate provided with the second electrode by using an adhesive;
(3) filling an electrophoretic medium into a plurality of cavities defined by the dams to form an electrophoretic display layer; and
(4) coating the surface of the electrophoretic display layer with the adhesive so that a coating thickness is controlled to be 15 μm, covering the adhesive with the first substrate, and exposing the adhesive to UV light for 30 minutes to cure, resulting in a display panel.

The adhesive used in the embodiment of the present disclosure includes an acrylate prepolymer, a photoinitiator, a crosslinking agent, and a conductive material. In a specific preparation process, 52 parts by mass of isooctyl acrylate (EHA), 35 parts by mass of isobornyl acrylate (IBOA), 12 parts by mass of hydroxyethyl acrylate (HEA), 1 part by mass of acrylamide (AM), and 0.1 part by mass of hydroxycyclohexyl phenyl ketone are fully and uniformly mixed, and then subjected to 365 nm ultraviolet light irradiation to react until the viscosity reaches 3500 cps, thereby obtaining the acrylate prepolymer. The prepolymer is uniformly mixed with 0.1% by mass of photoinitiator TPO, 0.1% by mass of crosslinking agent HDDA, 2% by mass of silver nanowires, and the additives as recited in Table 1 to obtain adhesive for the sealing layer.

According to the manufacturing steps of Embodiment One, embodiments and comparative embodiments were prepared and obtained. The specific process parameters for each embodiment are specifically shown in Table 1.

TABLE 1
Process parameters for manufacturing a display panel

| | | | | | | Bonding |
|---|---|---|---|---|---|---|
| | | Addition | | | | strength |
| | | amount of the | | Addition | | gf/25 |
| | Additive in | additive in the | | amount of the | | mm of |
| | electrophoretic | electrophetic | Additive in | additive in the | Material of | sealing |
| Sample(s) | medium | medium (%) | adhesive | adhesive % | dams | layer |
| Embodiment | Polydimethylsiloxane | 0.1 | γ-glycidoxypropyltri- | 1 | Polyacrylates | 676 |
| One | | | methoxysilane | | | |
| Embodiment | Polydimethylsiloxane | 0.5 | γ-glycidoxypropyltri- | 1 | Polyacrylates | 752 |
| Two | | | methoxysilane | | | |
| Embodiment | Polydimethylsiloxane | 0.5 | γ-methacryloxypropyltri- | 1 | Polyacrylates | 735 |
| Three | | | methoxysilane | | | |
| Embodiment | Perfluorooctanoic | 0.1 | / | 0 | Polyacrylates | 704 |
| Four | acid | | | | | |
| Embodiment | Poly | 0.1 | γ-glycidoxypropyltri- | 1 | Polyacrylates | 719 |
| Five | (methylhydrogen) | | methoxysilane | | | |
| | siloxane | | | | | |
| Embodiment | Poly | 0.5 | γ-glycidoxypropyltri- | 1 | Polyacrylates | 785 |
| Six | (methylhydrogen) | | methoxysilane | | | |
| | siloxane | | | | | |
| Embodiment | Poly | 0.5 | γ-methacryloxypropyltri- | 1 | Polyacrylates | 762 |
| Seven | (methylhydrogen) | | methoxysilane | | | |
| | siloxane | | | | | |
| Embodiment | Polydimethylsiloxane | 1 | γ-glycidoxypropyltri- | 1 | Polyacrylates | 742 |
| Eight | methylsulfonate | | methoxysilane | | | |
| Embodiment | Ethoxytrimethylolpropane | 0.1 | γ-glycidoxypropyltri- | 1 | Polyacrylates | 824 |
| Nine | triacrylate | | methoxysilane | | | |
| Embodiment | Ethoxytrimethylolpropane | 0.5 | γ-glycidoxypropyltri- | 1 | Polyacrylates | 866 |
| Ten | triacrylate | | methoxysilane | | | |
| Embodiment | Ethoxytrimethylolpropane | 0.5 | γ-methacryloxypropyltri- | 1 | Polyacrylates | 874 |
| Eleven | triacrylate | | methoxysilane | | | |
| Embodiment | propoxylated glycerol | 1 | γ-methacryloxypropyltri- | 1 | Polyacrylates | 815 |
| Twelve | triacrylate | | methoxysilane | | | |
| Comparative | None | 0 | γ-glycidoxypropyltri- | 1 | Polyacrylates | 478 |
| Embodiment | | | methoxysilane | | | |
| One | | | | | | |
| Comparative | None | 0 | γ-methacryloxypropyltri- | 1 | Polyacrylates | 462 |
| Embodiment | | | methoxysilane | | | |
| Two | | | | | | |

### [Peel Strength Testing Method for Sealing Layer]

A base material, a sealing layer, and a PET were pasted into a three-layer structure. The three-layer structure was cut into 120 mm*25 mm samples. The samples were pasted on a glass plate (wiped clean with alcohol) with an auxiliary adhesive, then rolled back and forth three times with a 2 kg roller, and allowed to stand for 24 h to perform a 180-degree peeling test at a speed of 300 mm/min.

After the test, the bonding strength of each of the sealing layers from Embodiments One to Twelve exceeded 500 gf/25 mm. It can be seen that due to the presence of the additive in the electrophoretic medium, the electrophoretic medium formed an interface raised towards the sealing layer, so that the contact area between the sealing layer and the dams was increased, improving the bonding strength between the sealing layer and the dams, enhancing the bonding strength of the liquid-liquid interface contact, and being conducive to improving the sealability of flexible packaging.

From the test data of Embodiments One to Four, it can be seen that with changes in the type and addition amount of the first additive in the electrophoretic medium, the bonding strength between the sealing layer and the dams did not change significantly. In Embodiment Two, the first additive was polydimethylsiloxane, which is an excellent silicon-based hydrophobic agent. Due to its low surface energy, the surface of the electrophoretic medium formed a centrally raised interface. Meanwhile, since polydimethylsiloxane can react with the additive Y-glycidoxypropyltrimethoxysilane in the adhesive to form Si—O—Si bonds and achieve chemical bonding, it can further enhance the interfacial connection force between the electrophoretic medium and the sealing layer formed by the adhesive. The bonding strength of the sealing layer reached 752 gf/25 mm, thereby improving the liquid-liquid interface bonding strength.

From the test data of Embodiments Five to Eight, it can be seen that as the type of the second additive in the electrophoretic medium changes, the bonding strength between the sealing layer and the dams did not change significantly. As the addition amount of the second additive in the electrophoretic medium increases, the bonding strength of the sealing layer also increases. Because the silicon-containing compound (e.g., poly(methylhydrogen-containing) siloxane or polydimethylsiloxane methylsulfonate) in the second additive can react with the additive γ-glycidoxypropyltrimethoxysilane or γ-methacryloxypropyltrimethoxysilane in the adhesive to form Si—O—Si bonds and achieve chemical bonding, it can further enhance the interfacial connection force between the electrophoretic medium and the sealing layer formed by the adhesive, thus improving the liquid-liquid interface bonding strength.

From the test data of Embodiment Nine to Embodiment Twelve, it can be seen that when the fourth additive in the electrophoretic medium is a multifunctional acrylic monomer, due to the low density of the multifunctional acrylic monomer, the fourth additive can float to the liquid surface of the electrophoretic medium. As a result, the liquid surface of the electrophoretic medium forms a centrally raised interface, which increases the contact area between the adhesive covering the electrophoretic medium and the dams, thereby improving the bonding strength between the sealing layer and the dams. Meanwhile, since the carbon-carbon double-bond active group of the multifunctional acrylic monomer provided in Embodiment Nine to Embodiment Twelve can undergo a cross-linking reaction with the carbon-carbon double-bond active group in the adhesive, the electrophoretic medium and the sealing layer are crosslinked to form a hardened layer. The hardened layer has intermolecular hydrogen bonds and can further improve the liquid-liquid interface bonding strength. The bonding strength of each of the sealing layers in Embodiments Nine to Twelve exceeded 800 gf/25 mm, improving the bonding strength between the sealing layer and the dams, enhancing the bonding strength of the liquid-liquid interface contact, and being conducive to improving the sealability of flexible packaging. In Comparative Embodiment 1, compared with Embodiment 1, no additive was added to the electrophoretic medium. As a result, it was difficult for the electrophoretic medium to form a raised interface, reducing the contact area between the sealing layer and the dams and decreasing the bonding strength between the sealing layer and the dams. Similarly, in Comparative Embodiment 2, compared with Embodiment 3, no additive was added to the electrophoretic medium. It was difficult for the electrophoretic medium to form a raised interface, reducing the contact area between the sealing layer and the dams and decreasing the bonding strength between the sealing layer and the dams.

The applicant states that the present disclosure describes the method and the core idea of the present disclosure through the above embodiments, but the present disclosure is not limited to the above embodiments, that is, it does not mean that the present disclosure must rely on the above embodiments to implement. It will be apparent to those of skill in the art that any improvements made to the present disclosure, equivalent replacements to the raw materials of the products of the present disclosure and addition of adjuvant ingredients, and choices of the specific implementations, etc., all fall within the protection scope and the disclosure scope of the present disclosure.

What is claimed is:

1. A display panel, comprising
a first substrate and a second substrate provided opposite to each other;
an electrophoretic display layer located between the first substrate and the second substrate, wherein the electrophoretic display layer comprises dams and accommodating cavities defined by the dams, and an electrophoretic medium is provided in the accommodating cavities; and
a sealing layer located between the electrophoretic display layer and the first substrate;
wherein the electrophoretic medium comprises a first additive, and a surface energy of the first additive is less than a surface energy of the electrophoretic medium.

2. The display panel according to claim 1, wherein
the electrophoretic medium forms an interface raised towards the sealing layer.

3. The display panel according to claim 1, wherein
the surface energy of the first additive is less than 25 mN/m.

4. The display panel according to claim 1, wherein
the first additive is a hydrophobic material, and a mass percentage of the hydrophobic material in the electrophoretic medium is 0.01% to 1%.

5. The display panel according to claim 1, further comprising:
a bonding layer located between the electrophoretic medium and the sealing layer;
wherein the electrophoretic medium comprises a second additive, the sealing layer comprises a third additive, the bonding layer is formed by a reaction between the second additive and the third additive, and the bonding layer is located on a surface of the sealing layer close to the electrophoretic display layer.

6. The display panel according to claim 5, wherein
the second additive comprises a silicon-containing compound, the third additive comprises a silane coupling agent, and the bonding layer has Si—O—Si chemical bonds.

7. The display panel according to claim 6, wherein
a chemical formula of the silicon-containing compound is represented by Formula I: 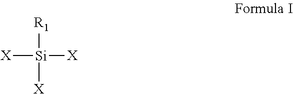
in the Formula I, X represents a hydrolyzable group, and R₁ is selected from an active group capable of interacting with an organic resin; and
a chemical formula of the silane coupling agent is R₂—Si(OM)₃, wherein R₂ is selected from the organic group, and OM represents a hydrolyzable alkoxy.

8. The display panel according to claim 7, wherein
X is selected from a halogen atom, an alkoxy group, and an acyloxy group; R₁ is selected from at least one of an amino group, a mercapto group, a vinyl group, an epoxy group, a cyano group, and a methacryloyloxy group; and R₂ is selected from at least one of an amino group, a vinyl group, a methyl group, an epoxy group, a mercapto group, and an acryloxypropyl group.

9. The display panel according to claim 6, wherein
a mass percentage of the second additive in the electrophoretic medium is 0.01% to 1%, and a mass percentage of the third additive in the sealing layer is 0.05% to 1%.

10. The display panel according to claim 1, further comprising:
a hardened layer located between the electrophoretic medium and the sealing layer;
wherein the electrophoretic medium comprises a fourth additive, a density of the fourth additive is lower than a density of the electrophoretic medium, the hardened layer is formed by a crosslinking reaction between the fourth additive and the sealing layer, and the hardened layer is located on a surface of the sealing layer close to the electrophoretic display layer.

11. The display panel according to claim 10, wherein
the fourth additive has a first active group, an adhesive used for forming the sealing layer has a second active group, and the first active group and the second active group each are independently selected from at least one of a carbon-carbon double bond, a hydroxyl group, a carboxyl group, an amino group, an epoxy group, an aldehyde group, and a haloalkyl group.

12. The display panel according to claim 10, wherein
the fourth additive comprises a multifunctional acrylic monomer with a density less than 1.2 g/mL.

13. The display panel according to claim 12, wherein
the multifunctional acrylic monomer comprises at least one of ethylene glycol diacrylate, 1,6-hexanediol diacrylate, 1,4-butanediol diacrylate, trimethylolpropane triacrylate, ethoxylated trimethylolpropane triacrylate, tetraethylene glycol dimethacrylate, trimethylolpropane triacrylate, propoxylated trimethylolpropane triacrylate, propoxylated glycerol triacrylate, and pentaerythritol triacrylate; and the sealing layer comprises polyacrylate and/or polymethacrylate.

14. The display panel according to claim 10, wherein
the hardened layer has intermolecular hydrogen bonds.

15. The display panel according to claim 10, wherein
a Shore hardness of the hardened layer is greater than 50 HA.

16. The display panel according to claim 1, wherein
materials of the dams and the first substrate include polymers with polar groups, and the sealing layer is connected to the dams and the first substrate through dipole-dipole interaction.

17. The display panel according to claim 1, wherein
within a range of a single accommodating cavity among the accommodating cavities, an included angle between the sealing layer sealing the accommodating cavities and a side wall of the dam is less than 90°.

18. The display panel according to claim 1, wherein
within a range of a single accommodating cavity among the accommodating cavities, an edge thickness H1 of the sealing layer sealing the accommodating cavity and a middle thickness H2 of the sealing layer satisfies: 1 nm≤H1-H2≤100 nm.

19. The display panel according to claim 1, wherein
an orthographic projection area of a top surface of the dam away from the second substrate on the second substrate is greater than an orthographic projection area of a bottom surface of the dam close to the second substrate on the second substrate.

20. A display apparatus, comprising a display panel, wherein the display panel comprises:
a first substrate and a second substrate provided opposite to each other;
an electrophoretic display layer located between the first substrate and the second substrate, wherein the electrophoretic display layer comprises dams and accommodating cavities defined by the dams, and an electrophoretic medium is provided in the accommodating cavities; and
a sealing layer located between the electrophoretic display layer and the first substrate;
wherein the electrophoretic medium comprises a first additive, and a surface energy of the first additive is less than a surface energy of the electrophoretic medium.
